(19) United States
(12) Patent Application Publication
(10) Pub. No.: US 2025/0199855 A1
(43) Pub. Date: Jun. 19, 2025

(54) WORKLOAD CONTROL SUPPORT DEVICE, AND WORKLOAD CONTROL SUPPORT METHOD

(71) Applicant: Hitachi, Ltd., Tokyo (JP)

(72) Inventors: Taku OKAMURA, Tokyo (JP); Satoshi KANEKO, Tokyo (JP); Yasutaka KONO, Tokyo (JP); Yoji OZAWA, Tokyo (JP)

(73) Assignee: Hitachi, Ltd., Tokyo (JP)

(21) Appl. No.: 18/846,022

(22) PCT Filed: Feb. 15, 2023
(86) PCT No.: PCT/JP2023/005218

§ 371 Date: Sep. 11, 2024

(30) Foreign Application Priority Data
Mar. 11, 2022 (JP) 2022-037794

(51) Int. Cl. G06F 9/48; G06F 1/329

(52) U.S. Cl. CPC G06F 9/4893; G06F 1/329

(57) ABSTRACT

A workload control support device includes: a parameter determination unit configured to acquire a prediction value of an executable period and a power consumption amount of each of a plurality of workloads that consume power scheduled to be executed in a future time period, and calculate, based on each acquired prediction value of the executable period and the power consumption amount, a target value of the power consumption amount in the future time period to satisfy a condition for a utilization rate of renewable energy in the power consumption in the future time period and a condition for cost related to utilization of the renewable energy; and a workload control unit configured to determine a timing of each workload to be executed in the future time period based on the calculated target value of the power consumption amount, and execute each workload at the determined timing.

### BACKGROUND

### Technical Field

The present invention relates to a workload control support device and a workload control support method.

### Background Art

[symbol]

### CROSS-REFERENCE TO RELATED APPLICATION

The present application claims the priority of Japanese Patent Application No. 2022-037794 filed on Mar. 11, 2022, the entire contents of which are incorporated herein by reference. In order to prevent emissions of greenhouse gases such as carbon dioxide, which is a cause of global warming, so-called decarbonization aiming at eliminating dependence on fossil fuels is attracting attention. In this regard, a large number of information processing devices and communication devices for executing a predetermined job are set in a data center (DC). These devices require a large amount of power to operate. Therefore, efforts are being made to achieve decarbonization by supplying such power using renewable energy sources.

In this case, it is important to maintain a utilization ratio of the renewable energy to power consumption (renewable energy utilization rate: re-energy rate), and it is preferable to maintain the re-energy rate over a finer time scale (for example, in units of hours rather than days).

In this regard, NPL 1 discloses that, in a job system including a batch job capable of changing an execution timing and an interactive job whose execution timing cannot be changed, a difference between a power generation amount by renewable energy and power consumption can be reduced by shifting the execution timing of the batch job.

### CITATION LIST

### Non-Patent Literature

NPL 1: Li, Y.; Wang, X.; Luo, P.; Pan, Q. Thermal-Aware Hybrid Workload Management in a Green Datacenter towards Renewable Energy Utilization. Energies 2019, 12, 1494. https://doi.org/10.3390/en12081494 [Retrieved Feb. 16, 2022]

### SUMMARY OF INVENTION

### Technical Problem

However, NPL 1 does not take cost involved in procurement of the renewable energy into consideration. The procurement of the renewable energy generally involves considerable cost, but NPL 1 fails to take such cost into consideration. In particular, cost effectiveness cannot be considered. In addition, NPL 1 is based on the premise that the power consumption to be generated in the future due to a workload and a workload plan are already known, whereas in reality there are not many cases in which these are known.

The present invention has been conceived in light of such a background, and an object thereof is to provide a workload control support device and a workload control support method capable of controlling each workload to be executed based on renewable energy while taking cost effectiveness into consideration.

### Solution to Problem

One aspect of the invention for solving the above problem is a workload control support device including: a processor; a memory; a parameter determination unit configured to acquire a prediction value of an executable period and a power consumption amount of each of a plurality of workloads that consume power scheduled to be executed in a future time period, and calculate, based on each acquired prediction value of the executable period and the power consumption amount, a target value of the power consumption amount in the future time period to satisfy a condition for a utilization rate of renewable energy in the power consumption in the future time period and a condition for cost related to utilization of the renewable energy; and a workload control unit configured to determine a timing of each workload to be executed in the future time period based on the calculated target value of the power consumption amount, and execute each workload at the determined timing.

### Advantageous Effects of Invention

According to the invention, each workload to be executed based on renewable energy can be controlled in consideration of cost effectiveness.

Problems, configurations, and effects other than those described above will be clarified by the following description of embodiments.

### BRIEF DESCRIPTION OF DRAWINGS

FIG. 1 is a diagram showing an example of a configuration of a workload control system according to an embodiment.

FIG. 2 is a diagram showing an example of hardware and functions of a workload control support device.

FIG. 3 is a diagram showing an example of a DC power prediction table.

FIG. 4 is a diagram showing an example of a time slot table.

FIG. 5 is a diagram showing an example of a delay limit time prediction distribution table.

FIG. 6 is a diagram showing an example of a user policy table.

FIG. 7 is a diagram showing an example of a workload table.

FIG. 8 is a diagram showing an example of a workload power consumption prediction distribution table.

FIG. 9 is a diagram showing an example of a prediction workload table.

FIG. 10 is a flowchart showing an outline of workload control processing.

FIG. 11 is a flowchart showing details of data update processing.

FIG. 12 is a flowchart showing workload deployment processing.

FIG. 13 is a flowchart showing an example of parameter determination processing.

FIG. 14 is a flowchart showing details of parameter creation processing.

FIG. 15 is a flowchart showing details of the parameter creation processing.

FIG. 16 is a flowchart showing an example of risk allowance calculation processing.

FIG. 17 is a flowchart showing details of per-viewpoint risk allowance calculation processing.

FIG. 18 is a flowchart showing IT workload control processing.

FIG. 19 is a flowchart showing the IT workload control processing.

FIG. 20 is a diagram showing an example of a workload transfer information screen.

### DESCRIPTION OF EMBODIMENTS

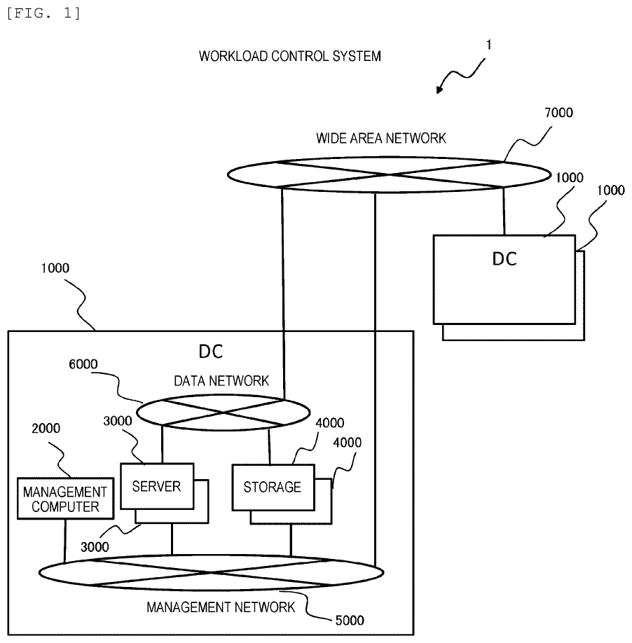

FIG. 1 is a diagram showing an example of a configuration of a workload control system 1 according to the present embodiment. The workload control system 1 includes one or a plurality of data centers 1000 (Data Center: DC). The data centers 1000 are communicably connected to each other by a wide area network 7000.

The data center 1000 includes a management computer 2000, one or a plurality of server devices 3000 used by an administrator or a user of the data center 1000, and one or a plurality of storage devices 4000 used by the administrator or the user of the data center 1000. The server device 3000 and the storage device 4000 are communicably connected via a data network 6000. The management computer 2000, the server device 3000, and the storage device 4000 are communicably connected to one another via a management network 5000.

The management network 5000, the data network 6000, and the wide area network 7000 are, for example, wired or wireless communication networks such as the Internet, a local area network (LAN), a wide area network (WAN), and dedicated lines.

The server device 3000 and the storage device 4000 execute various types of processing. For example, the server device 3000 and the storage device 4000 execute processing (hereinafter, referred to as an interactive job) that has a fixed execution time period (hereinafter, also referred to as a time slot), such as a Web application, as well as processing (hereinafter, referred to as a batch job) that does not necessarily have a fixed time slot but needs to be executed at least within a certain time period, such as processing related to artificial intelligence (AI) (for example, processing related to machine learning). Hereinafter, the batch job and the interactive job are collectively referred to as a job.

The management computer 2000 manages, in units of time slots, a processing load (hereinafter, referred to as batch workload) on the system (the data center 1000) due to a batch job that is executed or is scheduled to be executed in the future on the server device 3000 and storage device 4000. Similarly, the management computer 2000 manages, in units of time slots, a processing load (hereinafter, referred to as a batch interactive workload) on the system (the data center 1000) due to an interactive job that is executed or is scheduled to be executed in the future on the server device 3000 and the storage device 4000.

In the present specification, a workload may also be referred to as a job (processing).

Meanwhile, a certain amount of power is required to execute each process in the server device 3000 and the storage device 4000, and the data center 1000 is required to consume power from renewable energy rather than power from the power system at a predetermined ratio. That is, ratio the predetermined (utilization rate under a minimum condition) is referred to as a target value or a target rate of a renewable energy utilization rate in the embodiment. Further, the power generation amount of the renewable energy varies depending on the time period.

Here, the management computer 2000 according to the embodiment (workload control support device) sets a power consumption target value for the execution of each batch job in a future time slot, based on a prediction value of the power generation amount of renewable energy, taking into account the viewpoint of the re-energy rate and cost, and controls the execution timing of each batch job to maximize achievement of the power consumption target value (more specifically, determines the batch job to be executed in each time slot at a timing before the start of each time slot), thereby supporting maintenance of an appropriate balance between the re-energy rate and the cost in the data center 1000. Hereinafter, “renewable energy” may be abbreviated as “re-energy”.

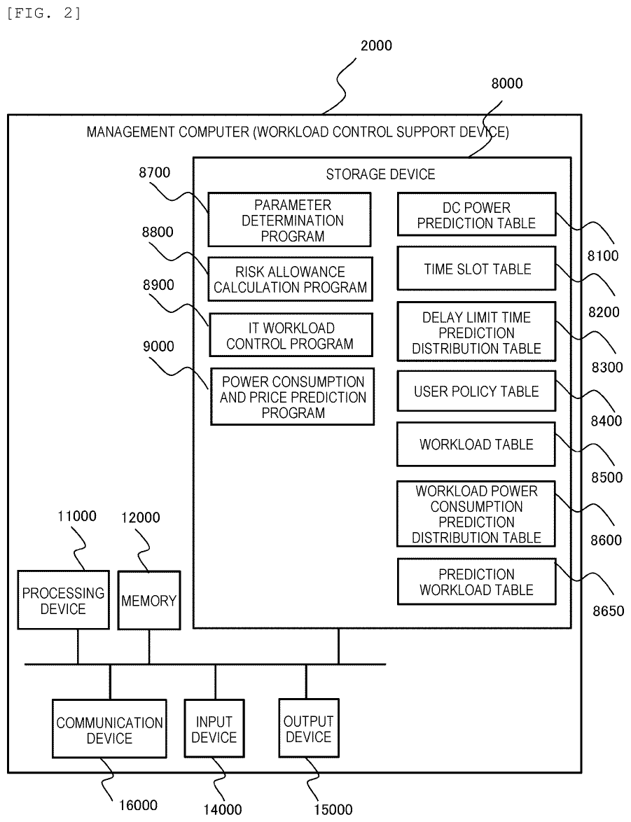

FIG. 2 is a diagram showing an example of hardware and functions of the management computer 2000 (workload control support device).

The management computer 2000 includes a processing device 11000 (processor) such as a central processing unit (CPU), a digital signal processor (DSP), a graphics processing unit (GPU), or a field-programmable gate array (FPGA); a main storage device 12000 (memory) such as a read only memory (ROM) or a random access memory (RAM); a storage device 8000 such as a hard disk drive (HDD) or a solid state drive (SSD); a communication device 16000 implemented by a network interface card (NIC), a wireless communication module, a universal serial interface (USB) module, or a serial communication module; an input device 14000 implemented by a mouse, a keyboard, or the like; and an output device 15000 implemented by a liquid crystal display or an organic electro-luminescence (EL) display, or the like.

The management computer 2000 stores programs of a parameter determination program 8700, a risk allowance calculation program 8800, an IT workload control program 8900, and a power consumption and price prediction program 9000.

The parameter determination program 8700 acquires prediction values of an executable period and a power consumption amount of each of a plurality of workloads scheduled to be executed in a future time slot. Further, the parameter determination program 8700 calculates, based on the prediction values of the executable period and the power consumption amount, a target value of the power consumption amount in the future time slot to satisfy a target value of the re-energy rate in the future time slot and a condition for cost related to utilization of the renewable energy.

In the embodiment, a delay limit time is used as the executable time. The delay limit time is the latest time that can be set as the execution timing of the batch job.

The parameter determination program 8700 receives a designation of a control principle as to which of the re-energy rate and the cost condition is emphasized, and when the control principle emphasizing the re-energy rate is designated, identifies a parameter α indicating a pattern of the execution timing of the batch workload which optimizes the utilization rate of the renewable energy, and calculates a target value of the power consumption amount in the future time slot based on the identified parameter α. On the other hand, when the control principle emphasizing the cost condition is designated, the parameter determination program 8700 identifies the parameter α indicating the pattern of the execution timing of the batch workload that optimizes the cost related to the use of the renewable energy, and calculates the target value of the power consumption amount in the future time slot based on the identified parameter α.

In the embodiment, the parameter α is a parameter indicating a ratio of the batch workload actually executed in a time slot among the batch workloads scheduled to be executed in a certain time slot up to that point. In the embodiment, the parameter α has a value from 0 to 1 for each time slot. This is merely an example, and another value may be adopted as long as the ratio of the batch workload to be actually executed among the batch workloads scheduled to be executed in a certain time slot is reflected.

The IT workload control program 8900 calculates a risk allowance indicating a risk due to uncertainty in the prediction value of the power consumption amount in the future time slot using a predetermined algorithm, determines a timing of each workload to be executed in the future time slot based on the calculated risk allowance and the target value of the power consumption amount, and executes each workload at the determined timing.

The risk allowance calculation program 8800 calculates the risk allowance based on a difference between a prediction value of the power generation amount related to the renewable energy in the future time slot and a target value of the power consumption amount in the future time slot.

The power consumption and price prediction program 9000 calculates a prediction value of the executable period and the power consumption amount of the workload to be executed in the future time slot, a prediction value of the power generation amount in the future time slot, a prediction value of a price of power in the future time slot, and the like.

Further, the management computer 2000 further stores each database of a DC power prediction table 8100, a time slot table 8200, a delay limit time prediction distribution table 8300, a user policy table 8400, a workload table 8500, a workload power consumption prediction distribution table 8600, and a prediction workload table 8650.

The DC power prediction table 8100 stores a power generation amount and a price of renewable energy predicted by the power consumption and price prediction program 9000, a predicted price of power provided by the power system, and actual values thereof.

The time slot table 8200 stores information on each time slot such as a prediction value and an actual value of power consumption in each time slot, a target value of power consumption, the parameter α, and the risk allowance.

The delay limit time prediction distribution table 8300 stores information on a distribution of prediction values of delay limit times of the workload in the future time slot.

The user policy table 8400 stores data of a policy (user policy) related to the use of renewable energy by the user, such as a target value of the re-energy rate (hereinafter, referred to as a target rate) and a control principle of the workload. In the embodiment, the renewable energy utilization rate (re-energy rate) is a ratio of the power consumption using renewable energy to the total power consumption in a certain time period, and may be based on other definitions.

The workload table 8500 stores and accumulates information related to an execution schedule of each workload (batch workload and interactive workload). The server device 3000 and the storage device 4000 execute each workload according to the workload table 8500.

The workload power consumption prediction distribution table 8600 stores information on distribution of prediction values of power consumption of each workload.

The prediction workload table 8650 stores prediction information for each workload of a future time slot.

Next, a specific example of each database will be described.

### (DC Power Prediction Table)

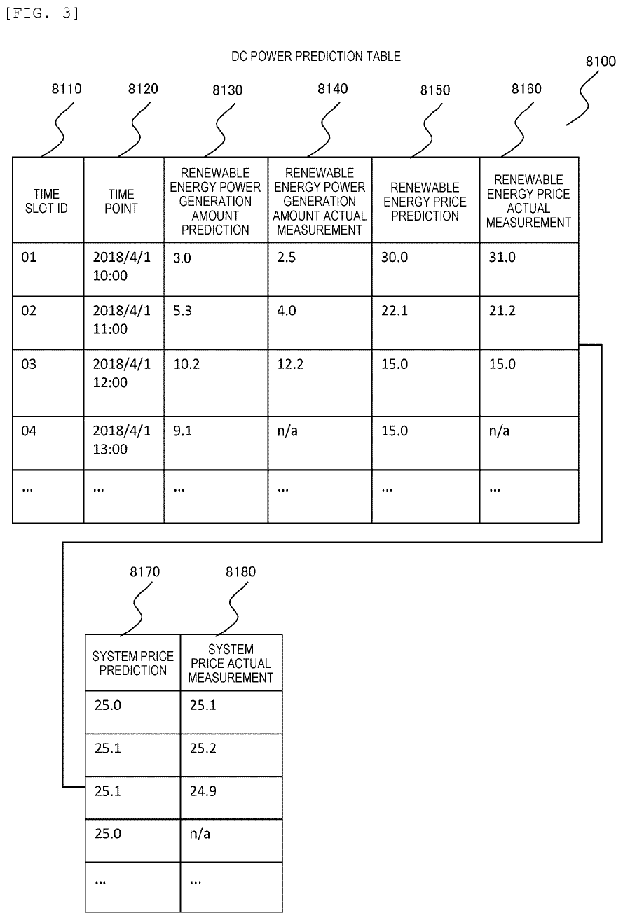

FIG. 3 is a diagram showing an example of the DC power prediction table 8100. The DC power prediction table 8100 includes one or more records each having a data item of a time slot ID 8110 in which identification information of a time slot is set, a time point 8120 at which a prediction or an actual measurement target time point is set, a renewable energy power generation amount prediction 8130 in which a prediction value of a renewable energy power generation amount (power that can be provided to the data center 1000) at the target time point is set, a renewable energy power generation amount actual measurement 8140 in which an actual measurement value of a power generation amount of renewable energy actually measured at a target time point is set, a renewable energy price prediction 8150 in which a prediction value of a price per unit power of renewable energy at a target time point is set, a renewable energy price actual measurement 8160 in which a price of renewable energy actually set at a target time point is set, a system price prediction 8170 in which a predicted price of power per unit amount (for example, 1 kW) at a target time point in a predetermined power system (for example, a commercial power system) is set, and a system price actual measurement 8180 in which a price of power per unit amount (for example, 1 kW) in the power system actually set at a target time point is set.

Actual measurement values and actual values in the DC power prediction table 8100 may be input by the user or may be automatically acquired from a predetermined database.

### (Time Slot Table)

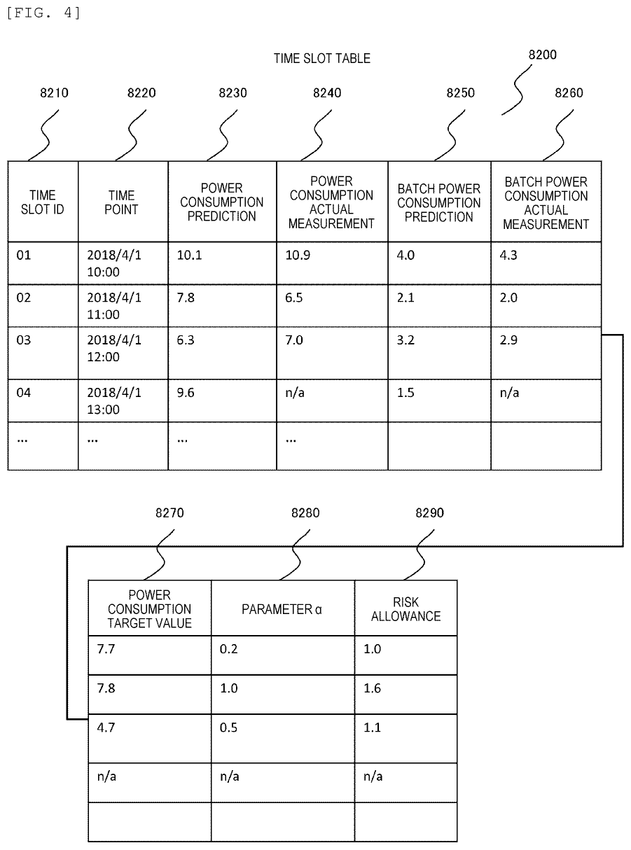

FIG. 4 is a diagram showing an example of the time slot table 8200. The time slot table 8200 includes one or more records each having a data item of a time slot ID 8210 in which the identification information of the time slot is set, a time point 8220 at which a start time point of the time slot is set, a power consumption prediction 8230 in which a prediction value of the power consumption of the data center 1000 in the time slot (power consumption for all facilities and devices in the data center including the server device 3000, the storage device 4000, and an air-conditioning facility (not shown), and the like) is set, a power consumption actual measurement 8240 in which the actual measurement value of the power consumption of the data center 1000 actually measured in the time slot is set, a batch power consumption prediction 8250 in which a prediction value of the power consumption of the batch workload in the time slot (hereinafter, also referred to as batch power consumption) is set, a batch power consumption actual measurement 8260 in which an actual measurement value of the power consumption of the batch workload in the time slot is set, a power consumption target value 8270 in which a target value of the power consumption of the data center 1000 in the time slot is set, a parameter α 8280 in which the parameter α in the time slot is set, and a risk allowance 8290 in which a risk allowance in the time slot is set.

### (Delay Limit Time Prediction Distribution Table)

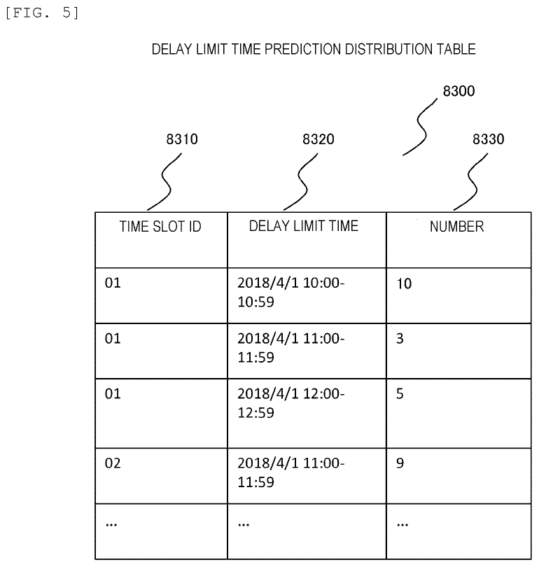

FIG. 5 is a diagram showing an example of the delay limit time prediction distribution table 8300. The delay limit time prediction distribution table 8300 includes one or more records each having a data item of a time slot ID 8310 in which identification information of a future time slot is set, a delay limit time 8320 in which a delay limit time of a workload in the time slot is set, and a number 8330 in which a prediction value of the number of workloads in the time slot having the delay limit time is set.

### (User Policy Table)

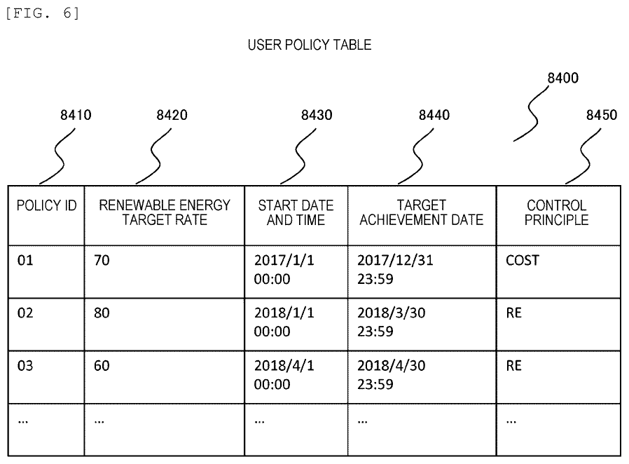

FIG. 6 is a diagram showing an example of the user policy table 8400. The user policy table 8400 includes one or more records each having a data item of a policy ID 8410 in which identification information of a user policy is set, a renewable energy target rate 8420 in which a target value (target rate) of a re-energy rate in the user policy is set, a start date and time 8430 in which an application start date and time of the user policy is set, a target achievement date 8440 in which an expiration date of the user policy is set, and a control principle 8450 in which a control principle for the renewable energy in the user policy is set.

In the control principle 8450, “COST” means that, in addition to utilization of the renewable energy, cost related to power use is also emphasized, and when an actual utilization rate of the renewable energy exceeds the target rate, the use of the renewable energy is limited (using power from a power system to make up for any shortfall), prioritizing reducing the cost related to the power use. “RE” means that the utilization of the renewable energy is emphasized, and no particular limitation is provided even when the actual utilization rate of the renewable energy exceeds the target rate (a maximum amount of renewable energy is used). The content of the control principle 8450 described here is merely an example, and information of another principle from the viewpoint of a balance between the cost and the utilization of the renewable energy may be set.

In the embodiment, the data in the user policy table 8400 is input in advance by the user, and the data may also be set or changed automatically.

### (Workload Table)

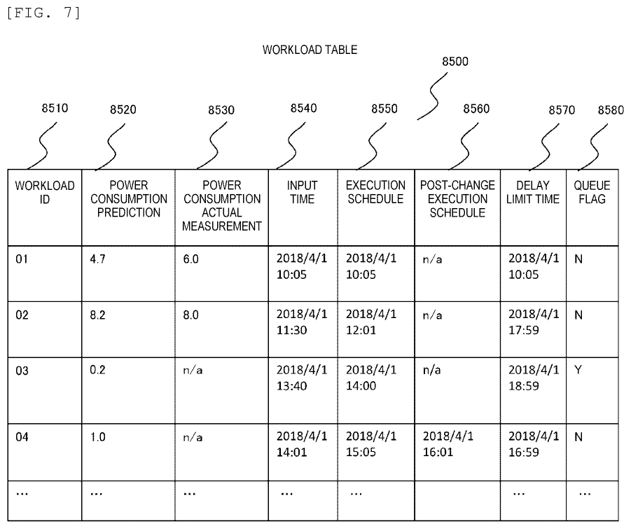

FIG. 7 is a diagram showing an example of the workload table 8500. The workload table 8500 includes one or more records each having a data item of a workload ID 8510 in which identification information of a workload is set, a power consumption prediction 8520 in which a prediction value of power consumption in the workload is set, a power consumption actual measurement 8530 in which an actual measurement value of the power consumption in the workload is set, an input time 8540 in which a time (input time) set first in the management computer 2000 with the information of the workload as an execution schedule is set, an execution schedule 8550 in which an execution timing of the workload is set, a post-change execution schedule 8560 in which the execution timing of the workload is changed (delayed) by the IT workload control program 8900, a delay limit time 8570 in which a delay limit time in the workload is set by the user, and a queue flag 8580 in which information indicating whether a queue flag is set to the workload is set.

When the workload is the interactive workload, a value of the execution schedule 8550 is automatically set to the same value as a value of the input time 8540. The queue flag 8580 is automatically set to “Y” when it is determined that the execution timing indicated by the execution schedule 8550 is delayed. A method for using the queue flag will be described later.

### (Workload Power Consumption Prediction Distribution Table)

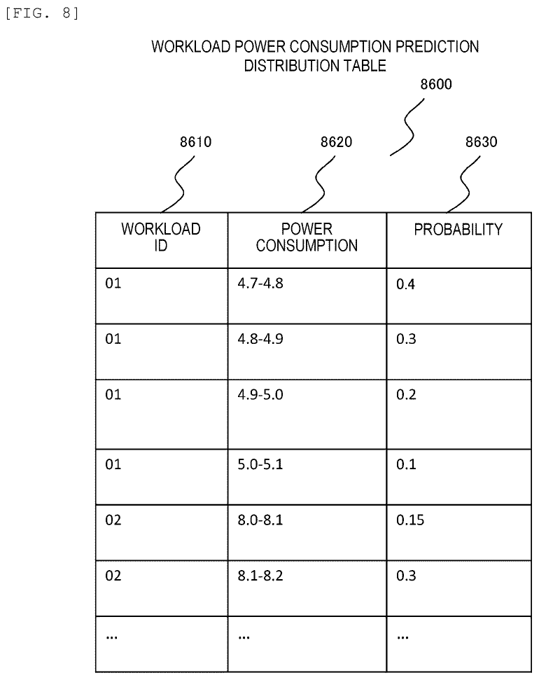

FIG. 8 is a diagram showing an example of the workload power consumption prediction distribution table 8600. The workload power consumption prediction distribution table 8600 includes one or more records each having a data item of a workload ID 8610 in which identification information of a workload is set, a power consumption 8620 in which a range of a prediction value of power consumption of the workload is set, and a probability 8630 in which a probability that the prediction value of the power consumption is realized is set. The workload power consumption prediction distribution table 8600 is generated whenever an actual measurement value of the past power consumption of each workload is acquired (a distribution of the prediction value of the power consumption is statistically calculated), and updated.

### (Prediction Workload Table)

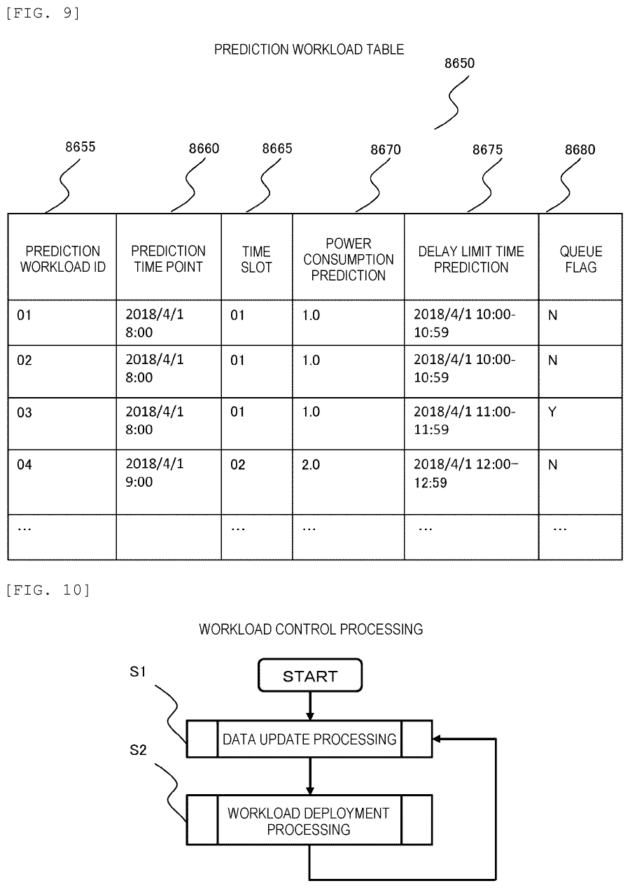

FIG. 9 is a diagram showing an example of the prediction workload table 8650. The workload table 8650 includes one or more records each having a data item of a prediction workload ID 8655 in which identification information of a workload of a predicted future time slot is set, a prediction time point 8660 indicating a time point at which the workload is predicted, a time slot 8665 indicating a time slot in which the workload is predicted, a power consumption prediction 8670 in which a prediction value of power consumption in the predicted workload is set, a delay limit time prediction 8675 in which a prediction value of a delay limit time in the predicted workload is set, and a queue flag 8680 in which information indicating whether a queue flag is set to the predicted workload is set.

Each program described above is executed by the processing device 11000 reading out the program stored in the main storage device 12000 or the storage device 8000. The program can be recorded on, for example, a recording medium and distributed. The management computer 2000 may be implemented, in whole or in part, using a virtual information processing resource provided using a virtualization technique, a process space isolation technique, or the like, such as a virtual server provided by a cloud system. All or a part of functions provided by the management computer 2000 may be implemented by, for example, a service provided by a cloud system via an application programming interface (API) or the like.

Next, processing executed by the management computer 2000 will be described.

### Workload Control Processing

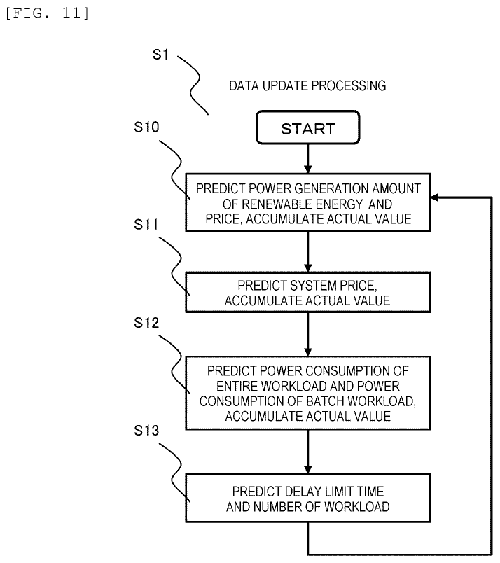

FIG. 10 is a flowchart showing an outline of workload control processing that is processing of controlling each workload in the data center 1000. The workload control processing is repeatedly executed at a predetermined time point (for example, every hour), a predetermined time interval (for example, before a predetermined time before the start of each time slot), or at a predetermined timing (time point designated by the user).

First, the management computer 2000 executes data update processing S1 of predicting a power generation amount and a price of power (power according to renewable energy or energy from a power system) used for an operation of the data center 1000, power consumption in the data center 1000, a prediction of a distribution of a delay limit time of each workload of the data center 1000, and accumulating past data. Details of the data update processing S1 will be described later.

Based on the data predicted and accumulated in the data update processing S1, the management computer 2000 executes workload deployment processing S2 of deploying (inputting) a workload to be actually executed from among the workloads in the data center 1000 that are scheduled to be executed in the most recent time slot. Details of the workload deployment processing S2 will be described later. The above processing is repeatedly executed.

Next, the data update processing S1 will be described in detail.

### Data Update Processing

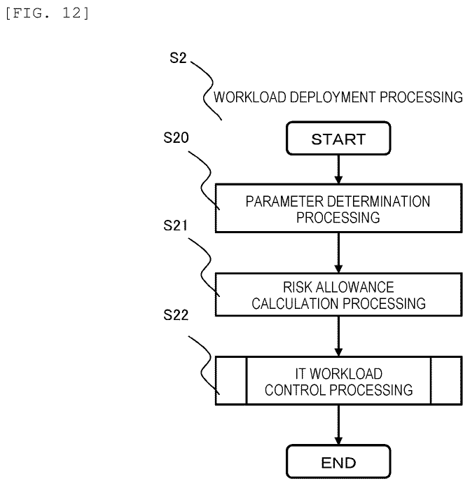

FIG. 11 is a flowchart showing details of the data update processing S1.

The power consumption and price prediction program 9000 predicts the power generation amount of the renewable energy and the price per unit power in each time slot after the present (S10). Specifically, for example, the power consumption and price prediction program 9000 acquires each value of the time point 8120, the renewable energy power generation amount actual measurement 8140, and the renewable energy price actual measurement 8160 of each record of the DC power prediction table 8100, and predicts the power generation amount of renewable energy and the price per unit power in each time slot after the present based on a predetermined algorithm (for example, executing time series analysis, and executing machine learning to create a prediction model) on the acquired value. The power consumption and price prediction program 9000 stores the predicted power generation amounts and the predicted prices in the renewable energy power generation amount prediction 8130 and the renewable energy price prediction 8150 of the records of the respective time slots of the DC power prediction table 8100.

The power consumption and price prediction program 9000 acquires the power generation amount of the renewable energy and the price per unit power in the past time slot from a predetermined device (for example, an external database or a server), and stores the acquired power generation amount and the acquired price as actual values in the renewable energy power generation amount actual measurement 8140 and the renewable energy price actual measurement 8160 of the record related to the time slot of the DC power prediction table 8100 (S10).

Further, the power consumption and price prediction program 9000 predicts the price per unit of the power of the power system in each time slot after the present (S11). Specifically, for example, the power consumption and price prediction program 9000 acquires each value of the time point 8120 and the system price actual measurement 8180 of each record of the DC power prediction table 8100, and predicts the price per unit of the power of the power system in each time slot after the present based on a predetermined algorithm (for example, executing time series analysis, and executing machine learning to create a prediction model) on the acquired value. The power consumption and price prediction program 9000 stores the predicted prices in the system price prediction 8170 of the records of the respective time slots of the DC power prediction table 8100.

The power consumption and price prediction program 9000 acquires the price per unit of the power of the power system in the past time slot from a predetermined device (for example, an external database or a server), and stores the acquired price as an actual value in the system price actual measurement 8180 of the record related to the time slot of the DC power prediction table 8100 (S11).

Further, the power consumption and price prediction program 9000 predicts a power consumption amount of the entire data center 1000 and a power consumption amount of the batch workload in each time slot after the present (S12). Specifically, for example, the power consumption and price prediction program 9000 acquires the values of the time point 8220, the power consumption actual measurement 8240, and the batch power consumption actual measurement 8260 of each record of the time slot table 8200, and predicts the power consumption amount of the entire data center 1000 and the power consumption amount of the batch workload in each time slot after the present, based on a predetermined algorithm (for example, executing time series analysis, and executing machine learning to create a prediction model) on each acquired value. The power consumption and price prediction program 9000 stores the predicted power consumption in the power consumption prediction 8230 and the batch power consumption prediction 8250 of the records of the respective time slots of the time slot table 8200.

The power consumption and price prediction program 9000 acquires the power consumption amount of the entire data center 1000 and the power consumption amount of the batch workload in the past time slot from a predetermined device (for example, an external database or a server), and stores the acquired power consumption amounts as actual values in the power consumption actual measurement 8240 and the batch power consumption actual measurement 8260 of the record related to the time slot of the DC power prediction table 8100 (S12).

Further, the power consumption and price prediction program 9000 predicts a delay limit time of the batch workload of the data center 1000 in each time slot after the present (S13). Specifically, for example, the power consumption and price prediction program 9000 acquires the execution schedule 8550 (time point at which the past workload is actually executed), the post-change execution schedule 8560, and the delay limit time 8570 of the workload table 8500, and predicts a distribution of the delay limit times for each batch workload in each time slot after the present based on a predetermined algorithm (for example, executing time series analysis, and executing machine learning to create a prediction model) on each acquired value. The power consumption and price prediction program 9000 stores the data of the predicted distribution of the delay limit time in the delay limit time 8320 and the number 8330 of the records of respective time slots of the delay limit time prediction distribution table 8300. The power consumption and price prediction program 9000 creates a new record in the prediction workload table 8650 by the number of the number 8330 predicted in each time slot, and stores the data of the time slot and the delay limit time in the time slot 8665 and the delay limit time prediction 8670 of the prediction workload table 8650, respectively. Thereafter, the processing from S10 onward is repeated.

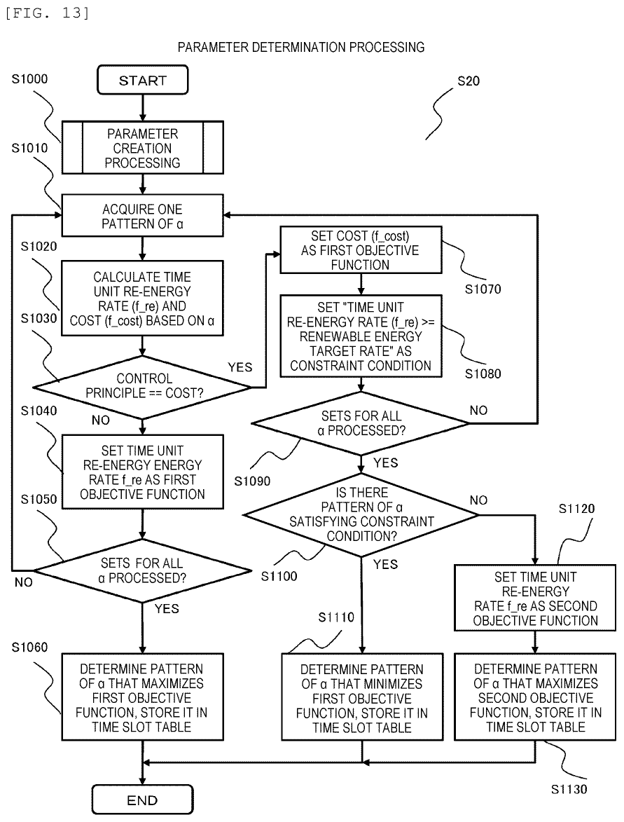

FIG. 12 is a flowchart showing the workload deployment processing S2.

The parameter determination program 8700 executes parameter determination processing S20 of determining a pattern of the parameter α in each time slot after the most recent time slot.

In addition, the risk allowance calculation program 8800 executes risk allowance calculation processing S21 of calculating the risk allowance in each time slot after the most recent time slot.

Then, the IT workload control program 8900 determines a batch workload to be executed in the most recent time slot based on a target value of the power consumption amount calculated based on the pattern of the parameter α determined in the parameter determination processing S20 and the risk allowance calculated in the risk allowance calculation processing S21, and executes IT workload control processing S22 of deploying the determined batch workload together with an interactive workload.

Hereinafter, details of the parameter determination processing S20, the risk allowance calculation processing S21, and the IT workload control processing S22 will be described.

### Parameter Determination Processing

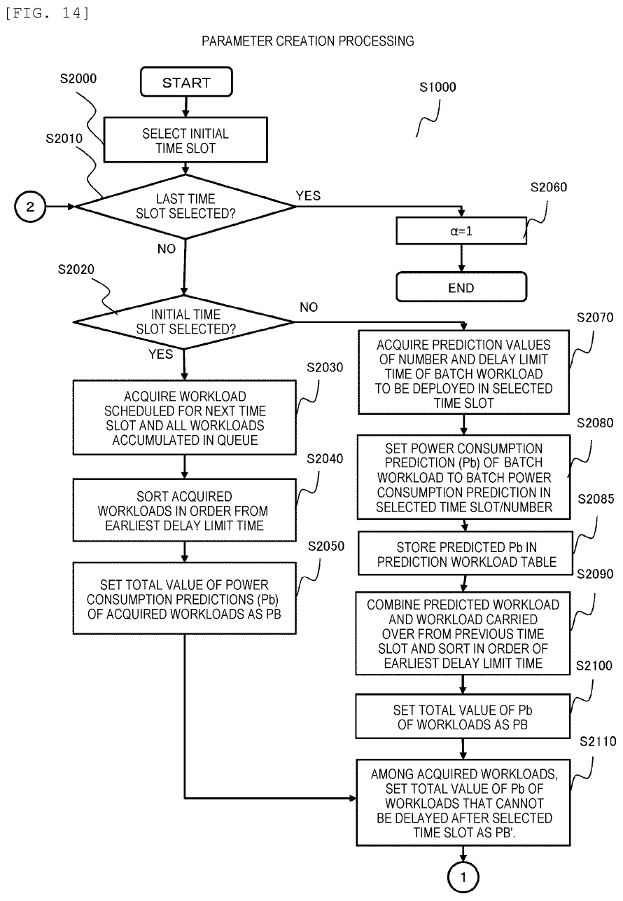

FIG. 13 is a flowchart showing an example of the parameter determination processing S20. In the parameter determination processing, in order to achieve an operation principle designated by the user in the user policy table 8400, a deployment amount of the ideal batch workload in each future time slot is determined. The deployment amount of the batch workload is determined by identifying the parameter α that determines an execution ratio of the batch workload in each time slot. Since the deployment amount of the batch workload is determined by identifying the parameter α, the power consumption amount in each time slot can be calculated, and a utilization rate of the renewable energy (time unit re-energy rate) and cost related to the use of the renewable energy can be calculated. Therefore, the optimal parameter α for achieving the operation principle identified by the user is determined by calculating the possible parameter α.

First, the parameter determination program 8700 executes parameter pair creation processing S1000, and executes the parameter creation processing S1000 for creating one or a plurality of lists (patterns) of the parameters α of the most recent and subsequent time slots. Details of the parameter creation processing S1000 will be described later.

The parameter determination program 8700 acquires one pattern from among the patterns of the parameter α determined in the parameter creation processing S1000 (S1010).

The parameter determination program 8700 calculates the utilization rate of renewable energy (time unit re-energy rate f_re) and cost f_cost related to the use of renewable energy in all time slots for which the parameter α is calculated (S1020). In the embodiment, the cost f_cost related to the use of the renewable energy takes only power cost of the renewable energy into consideration, and the cost may also include system power cost and other types of cost.

That is, the parameter determination program 8700 calculates a power consumption target value by adding a value obtained by dividing the power consumption prediction 8230 of the time slot table 8200 by the batch power consumption prediction 8250 and a value obtained by multiplying the value of the batch power consumption 8250 by the parameter α. By referring to the renewable energy power generation amount prediction 8230 (renewable energy which can be supplied to the data center 1000) of the DC power prediction table 8100, it is determined whether the power consumption under the power consumption target value can be covered with renewable energy. When the power consumption cannot be covered, it is identified that a difference will be covered by the power system. Accordingly, the parameter determination program 8700 can calculate the utilization rate of renewable energy (time unit re-energy rate f_re). The parameter determination program 8700 can calculate the cost f_cost related to the use of the renewable energy by multiplying the prediction value of the power consumption of the renewable energy by the renewable energy price prediction 8150 of the DC power prediction table 8100.

Next, the parameter determination program 8700 checks whether the control principle is “COST” (S1030). For example, the parameter determination program 8700 refers to the user policy table 8400 and checks whether the value of the control principle 8450 of the latest record is “COST”.

When the control principle is “COST” (S1030: YES), the parameter determination program 8700 executes the processing of S1070. When the control principle is “RE” (S1030: NO), the parameter determination program 8700 executes the processing of S1040.

In S1040, the parameter determination program 8700 sets the time unit re-energy rate f_re as a first objective function. In this case, since the user emphasizes the utilization of the renewable energy, the parameter α that maximizes the time unit re-energy rate f_re is determined.

The parameter determination program 8700 checks whether the first objective function is set for all the patterns of the parameter α (S1050). When the first objective function is set for all the patterns of the parameter α (S1050: YES), the parameter determination program 8700 executes the processing of S1060. When there is a pattern of the parameter α for which the first objective function is not set (S1050: NO), the parameter determination program 8700 repeats the processing from S1010 onwards to acquire that pattern of the parameter α.

In S1060, the parameter determination program 8700 identifies the pattern of the parameter α having a maximum value of the first objective function from among the patterns of the plurality of parameters α created in the parameter creation processing S1000, and sets an identification result as a parameter a 8280 of the record related to each time slot of the time slot table 8200. With the above, the parameter determination processing S20 ends.

On the other hand, in S1070, the parameter determination program 8700 sets the cost f_cost as the first objective function. In this case, in addition to the utilization of the renewable energy by the user, the cost related to the power use is emphasized. Therefore, when the actual utilization rate of the renewable energy exceeds the target rate, the parameter α is determined to minimize the cost f_cost within a range in which the time unit re-energy rate does not fall below the target rate. However, when the actual utilization rate of the renewable energy is lower than the target rate, priority is given to achieving the utilization rate of the renewable energy equal to or greater than the target rate, and the parameter α is determined to maximize the time unit re-energy rate f_re.

In addition, the parameter determination program 8700 sets a constraint condition in the first objective function that the time unit re-energy rate f_re is equal to or greater than the renewable energy target rate (satisfies a minimum condition for the re-energy rate) (S1080). The parameter determination program 8700 uses the value of the renewable energy target rate 8420 of the latest record of the user policy table 8400 as the renewable energy target rate.

The parameter determination program 8700 checks whether the first objective function is executed for all the patterns of the parameters α (S1080). When the first objective function is executed for all the patterns of the parameters α (S1080: YES), the parameter determination program 8700 executes the processing of S1090. When there is a pattern of the parameter α for which the first objective function is not set (S1080: NO), the parameter determination program 8700 repeats the processing from S1010 onwards to acquire that pattern of the parameter α.

In S1100, the parameter determination program 8700 checks whether there is a pattern of the parameter α satisfying the constraint condition. When there is a pattern of the parameter α satisfying the constraint condition (S1100: YES), the parameter determination program 8700 executes the processing of S1110. When there is no pattern of the parameter α satisfying the constraint condition (S1100: NO), the parameter determination program 8700 executes the processing of S1120.

In S1110, the parameter determination program 8700 identifies the pattern of the parameter α having the minimum value of the first objective function from among the patterns of the plurality of parameters α created in the parameter creation processing S1010, and sets the identification result as the parameter α 8280 of the record related to each time slot of the time slot table 8200. With the above, the parameter determination processing S20 ends.

In S1120, the parameter determination program 8700 sets the time unit re-energy rate f_re as a second objective function.

Then, the parameter determination program 8700 identifies the pattern of the parameter α having a maximum value of the second objective function from among the patterns of the plurality of parameters α created in the parameter creation processing S1010, and sets the identification result as the parameter α 8280 of the record related to each time slot of the time slot table 8200 (S1130). With the above, the parameter determination processing S20 ends.

### Parameter Creation Processing

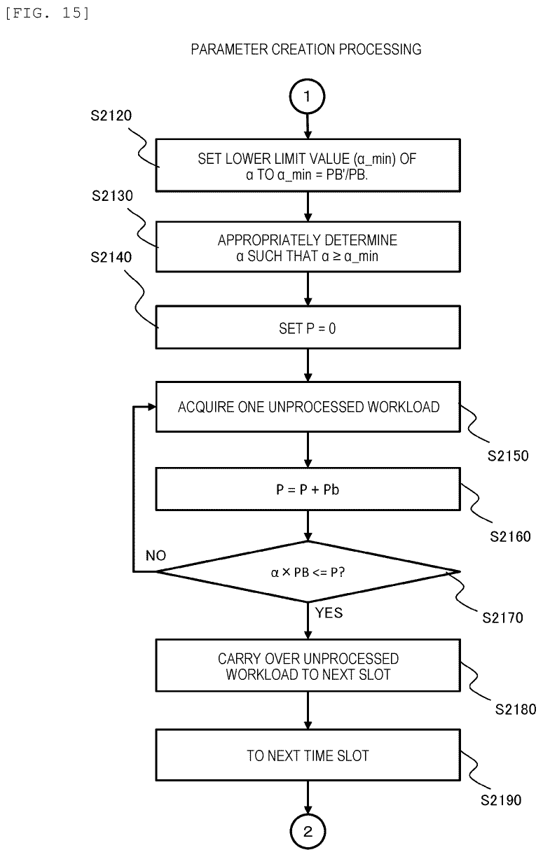

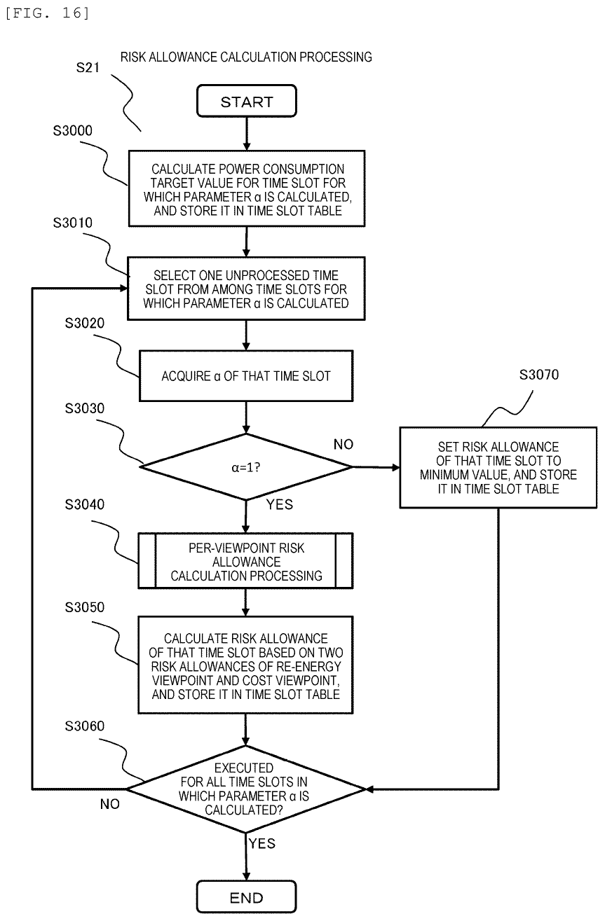

FIGS. 14 and 15 are flowcharts showing details of the parameter creation processing S1000 (divided into two diagrams for convenience of the drawing). In the parameter creation processing S1000, a set of all possible parameters α is created. Since the delay limit time 8570 for a batch workload is set by the user, the execution may not be delayed at any time. Therefore, the deployment amount of the batch workload is not completely freely determined in each time slot. Therefore, the parameter α in each time slot needs to be limited, and a limit is set on the parameter α based on the information on a prediction distribution of the delay limit times in the delay limit time prediction distribution table 8300, and a set of parameters α that can be taken within that range is created.

As shown in FIG. 14, the parameter determination program 8700 selects a most recent time slot (S2000). Specifically, the parameter determination program 8700 refers to the time slot table 8200 and selects a record indicating a future time point closest to the current time point by the time point 8220.

The parameter determination program 8700 determines whether the selected time slot is the last time slot (S2010). Specifically, the parameter determination program 8700 checks whether the selected time slot is the last time slot for which the timing is set in advance (for example, a time slot after 12 hours).

When the selected time slot is the last time slot (S2010: YES), the parameter determination program 8700 executes the processing of S2060. When the selected time slot is not the last time slot (S2010: NO), the parameter determination program 8700 executes the processing of S2020.

In S2060, the parameter determination program 8700 deploys all the batch workloads for the last time slot, sets the parameter a of the selected time slot (last time slot) to 1, and ends the parameter creation processing S1000.

In S2020, the parameter determination program 8700 determines whether the selected time slot is the initial time slot. Specifically, the parameter determination program 8700 checks whether the time point 8220 of the record selected in S2000 indicates the future time point closest to the current time point.

When the selected time slot is the initial time slot (S2020: YES), the parameter determination program 8700 executes the processing of S2030. When the selected time slot is not the initial time slot (S2020: NO), the parameter determination program 8700 executes the processing of S2070.

Steps S2030 to S2050 are processing when the selected time slot is the initial time slot. In the initial time slot, since the batch workload is already set in the time slot, the delay limit time is acquired based on the information of the batch workload, and the power consumption is predicted. On the other hand, steps S2070 to S2110 are processing when the selected time slot is not the initial time slot. When the selected time slot is not the initial time slot, since the batch workload is not set in the next time slot, the batch workload is not yet registered in the workload table 8500. Therefore, it is necessary to predict the batch workload, and the prediction of the delay limit time and the prediction of the power consumption are performed.

In S2030, the parameter determination program 8700 acquires the batch workload set in the selected time slot and all batch workloads accumulated in the time slot immediately before the selected time slot as a current queue. Specifically, the parameter determination program 8700 refers to the workload table 8500 and acquires data of a record related to the selected time slot and data of all records of which the queue flag 8580 is “Y”.

The parameter determination program 8700 sorts the respective batch workloads acquired in S2030 in an ascending order of the delay limit time (from one with the earliest order) (S2040). Specifically, the parameter determination program 8700 refers to the workload table 8500 and sorts the records in the order of the delay limit time 8570 of each record acquired in S2030 being close to the current time point.

The parameter determination program 8700 calculates a workload power consumption prediction total value PB, which is a total value of prediction values Pb of the power consumption of the batch workloads sorted in S2040 (S2050). Specifically, the parameter determination program 8700 refers to the workload table 8500 and sums up the values of the power consumption prediction 8520 of each record related to the workloads sorted in S2040. Thereafter, the processing of S2110 is performed.

On the other hand, in S2070, the parameter determination program 8700 acquires prediction values of the number of batch workloads to be deployed (executed) in the selected time slot and the delay limit time of the batch workload. Specifically, the parameter determination program 8700 refers to the delay limit time prediction distribution table 8300 and acquires the values of the delay limit time 8320 and the number 8330 of the record related to the selected time slot.

The parameter determination program 8700 calculates the prediction value Pb of the power consumption per batch workload in the selected time slot by dividing the prediction value of the batch power consumption in the selected time slot by the number of batch workloads calculated in S2070 (S2080).

Specifically, the parameter determination program 8700 refers to the time slot table 8200, acquires the batch power consumption prediction 8250 of the record related to the selected time slot, and divides the acquired value of the power consumption by the value of the number 8330 acquired in S2070.

The parameter determination program 8700 stores the calculated prediction value of the batch power consumption in the prediction workload table 8650 (S2085).

Specifically, the parameter determination program 8700 stores the prediction value Pb calculated in S2080 in the power consumption prediction 8670 of the record having the time slot 8665 that matches with the selected time slot in the record having the latest prediction time point 8660.

The parameter determination program 8700 acquires the batch workload in which the prediction value Pb of the power consumption is acquired in S2070 and the batch workloads accumulated as the current queue among the batch workloads of the immediately preceding time slots. Then, the parameter determination program 8700 sorts the acquired batch workloads in an ascending order of the delay limit time (S2090).

Specifically, for example, the parameter determination program 8700 refers to the workload table 8500 and acquires data of a record of which the queue flag 8580 is “Y”. Further, the parameter determination program 8700 refers to the prediction workload table 8650, and acquires the data of the record in which the prediction time point 8660 is the latest and the queue flag 8675 is “Y” and data of the record in which the prediction time 8660 is the latest and in which the time slot 8665 is the same as the selected time slot. The parameter determination program 8700 sorts the delay limit time prediction 8675 of the prediction workload table 8650 and the delay limit time 8570 of the acquired record of the workload table 8500.

The parameter determination program 8700 calculates the workload power consumption prediction total value PB, which is the total value of the prediction values Pb of the power consumption of batch workloads sorted in S2090 (S2100). Specifically, the parameter determination program 8700 sums up the prediction value Pb indicated by the power consumption prediction 8520 or the power consumption prediction 8670 of each record in which in S2090 the queue flag 8580 is “Y”, the prediction time point 8660 is the latest and the queue flag 8675 is “Y”, or the prediction time point 8660 is the latest and the time slot 8665 is the same as the selected time slot. Thereafter, the processing of S2110 is performed.

In step S2110, the parameter determination program 8700 identifies all workloads that cannot be set (cannot be delayed) in the time slot after the selected time slot among the workloads for which the prediction values Pb of the power consumption are calculated in S2050 or S2100, and calculates a total value of the prediction values Pb of the power consumption of each of the identified workload (a non-delay workload power consumption prediction total value PB′). Specifically, the parameter determination program 8700 refers to the workload table 8500 and the prediction workload table 8650, identifies a workload of a record in which a time of the delay limit time 8570 or the delay limit time prediction 8675 is the same as a time of the selected time slot, and sets the total value of the prediction values Pb of the power consumption of the identified workloads as the non-delay workload power consumption prediction total value PB′. The power consumption due to the batch workload of PB′ is always consumed in the time slot.

Then, as shown in FIG. 15, the parameter determination program 8700 sets PB′/PB as a lower limit value α_min of the parameter α of the selected time slot (S2120).

In this manner, the parameter determination program 8700 preferentially executes the batch workload which is earlier in the delay limit time at an earlier timing.

Then, the parameter determination program 8700 freely determines one or a plurality of values of a of the selected time slot that is equal to or greater than the lower limit value α_min (S2130).

The parameter determination program 8700 sets a power consumption determination value P to 0 (S2140).

The parameter determination program 8700 adds the prediction value Pb of the power consumption of each workload to the determination value P in the order of the workloads sorted in S2040 or S2090 (S2150, S2160). The parameter determination program 8700 repeats the addition until the determination value P exceeds a multiplication value of the PB calculated in S2050 or S2100 and the α set in S2130 (S2170: NO).

When the power consumption value P is equal to or greater than the multiplication value of PB and α (S2170: YES), the parameter determination program 8700 accumulates the workloads that are not subjected to the multiplication in the queue (S2180). Specifically, the parameter determination program 8700 refers to the workload table 8500 and the prediction workload table 8650, and sets the queue flag 8580 or the queue flag 8680 of the record related to the workload not subjected to the multiplication to “Y”.

The parameter determination program 8700 selects the next time slot of the selected time slot and repeats the processing from S2010 onwards (S2190).

In S2130, the parameter determination program 8700 sets a plurality of values as the value of α for the selected time slot (for example, if the lower limit value α_min is 0.1, then the values are set to 0.1, 0.2, 0.3, 0.4, . . . , 1), and performs processing from S2140 onwards for each of them, thereby creating a plurality of patterns of the parameter α.

### Risk Allowance Calculation Processing

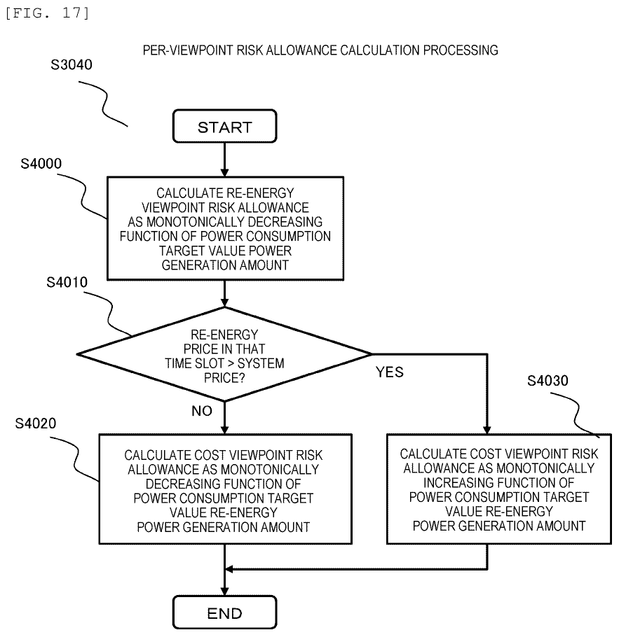

FIG. 16 is a flowchart showing an example of the risk allowance calculation processing S21.

The risk allowance calculation program 8800 calculates a power consumption target value for each time slot based on the parameter α of each time slot determined in the parameter determination processing S20, and stores each calculated power consumption target value in the power consumption target value 8270 of the time slot table 8200 (S3000).

For example, the risk allowance calculation program 8800 refers to the time slot table 8200 and adds a value obtained by dividing the power consumption prediction 8230 of the record of each time slot by the batch power consumption prediction 8250 and a value obtained by multiplying the value of the batch power consumption 8250 and the parameter α.

The risk allowance calculation program 8800 selects one time slot from among the time slots for which the parameter α is calculated in the parameter determination processing S20 (S3010).

The risk allowance calculation program 8800 acquires the parameter α of the selected time slot (S3020).

The risk allowance calculation program 8800 checks whether the acquired parameter α is 1 (S3030).

When the acquired parameter α is 1 (S3030: YES), the risk allowance calculation program 8800 executes the processing of S3040. When the acquired parameter α is not 1 (S3030: NO), the risk allowance calculation program 8800 executes the processing of S3070.

In S3070, the risk allowance calculation program 8800 sets a risk allowance related to the selected time slot to a minimum value (1 in the embodiment), and stores the minimum value in the time slot table 8200 (specifically, in the risk allowance 8290 of the record related to the selected time slot of the time slot table 8200). Thereafter, the processing of S3060 is performed.

In S3040, the risk allowance calculation program 8800 executes per-viewpoint risk allowance calculation processing S3040 of calculating a re-energy viewpoint risk allowance and a cost viewpoint risk allowance. Details of the per-viewpoint risk allowance calculation processing S3040 will be described later.

Then, the risk allowance calculation program 8800 calculates a risk allowance in the selected time slot based on the re-energy viewpoint risk allowance and the cost viewpoint risk allowance calculated in S3040 (S3050).

For example, the risk allowance calculation program 8800 calculates a multiplication value of the re-energy viewpoint risk allowance and the cost viewpoint risk allowance or an exponentiation value (for example, a square root) of the multiplication value. A calculation method described here is merely an example, and another calculation method may be adopted as long as a magnitude of each value of the re-energy viewpoint risk allowance and the cost viewpoint risk allowance is reflected in the risk allowance in the selected time slot.

In addition, the risk allowance calculation program 8800 may reflect the control principle in the risk allowance in the selected time slot. For example, the risk allowance calculation program 8800 may acquire the control principle 8450 of the latest record in the user policy table 8400, and, when the control principle is “RE”, may set a value of the re-energy viewpoint risk allowance or a value obtained by multiplying the re-energy viewpoint risk allowance by a predetermined coefficient as the risk allowance in the selected time slot.

The risk allowance calculation program 8800 determines whether the risk allowance is calculated for all the time slots in which the parameter α is calculated by the parameter determination processing S20 (S3060).

When the risk allowance is calculated for all the time slots (S3060: YES), the risk allowance calculation processing ends. When there is a time slot in which the risk allowance is not calculated (S3060: NO), the risk allowance calculation program 8800 repeats the processing from S301 onwards to select a time slot for which the risk allowance is not calculated.

### Per-Viewpoint Risk Allowance Calculation Processing

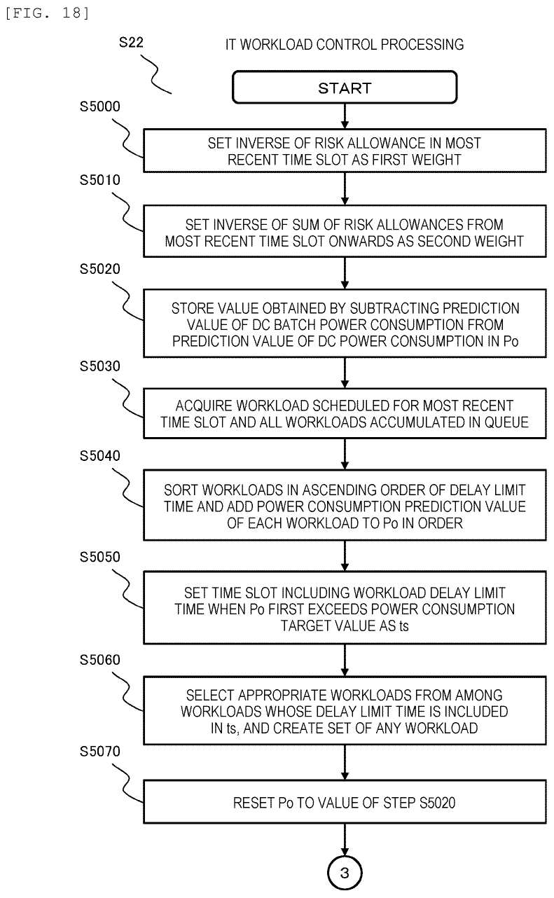

FIG. 17 is a flowchart showing details of the per-viewpoint risk allowance calculation processing S3040.

The risk allowance calculation program 8800 calculates the re-energy viewpoint risk allowance (the allowance regarding the risk that the utilization of renewable energy is not sufficient due to the re-energy rate not reaching the target rate) such that the value decreases as the power generation amount of the renewable energy of the selected time slot exceeds the target value of the power consumption (S4000).

For example, the risk allowance calculation program 8800 calculates the re-energy viewpoint risk allowance based on (predetermined negative coefficient)×(target value of power consumption−power generation amount of renewable energy). The formula shown here is one example, and another formula representing a monotonic decrease may be used.

The risk allowance calculation program 8800 checks whether the price per unit power of renewable energy of the selected time slot is greater than the price per unit power of the system (S4010). Specifically, the risk allowance calculation program 8800 refers to the DC power prediction table 8100 and checks by identifying the values of the renewable energy price prediction 8150 and the system price prediction 8170 of the record related to the selected time slot.

When the price per unit power of renewable energy is greater than the price per unit power of the system (S4010: YES), the risk allowance calculation program 8800 executes the processing of S4030. When the price per unit power of renewable energy is equal to or less than the price per unit power of the system (S4010: NO), the risk allowance calculation program 8800 executes the processing of S4020.

In S4030, the risk allowance calculation program 8800 calculates the cost viewpoint risk allowance (the allowance regarding the risk of increasing the cost due to the excessive use of renewable energy) such that the value increases as the power generation amount of the renewable energy of the selected time slot exceeds the target value of the power consumption. With the above, the per-viewpoint risk allowance calculation processing S3040 ends.

For example, the risk allowance calculation program 8800 calculates the re-energy viewpoint risk allowance based on (predetermined positive value coefficient)×(target value of power consumption−power generation amount of renewable energy). The formula shown here is one example, and another formula representing a monotonic increase may be used.

In S4020, the risk allowance calculation program 8800 calculates the cost viewpoint risk allowance such that the value decreases as the power generation amount of the renewable energy of the selected time slot exceeds the target value of the power consumption. With the above, the per-viewpoint risk allowance calculation processing S3040 ends.

For example, the risk allowance calculation program 8800 calculates the re-energy viewpoint risk allowance based on (predetermined negative value coefficient)×(target value of power consumption−power generation amount of renewable energy). The formula shown here is one example, and another formula representing a monotonic decrease may be used.

### IT Workload Control Processing

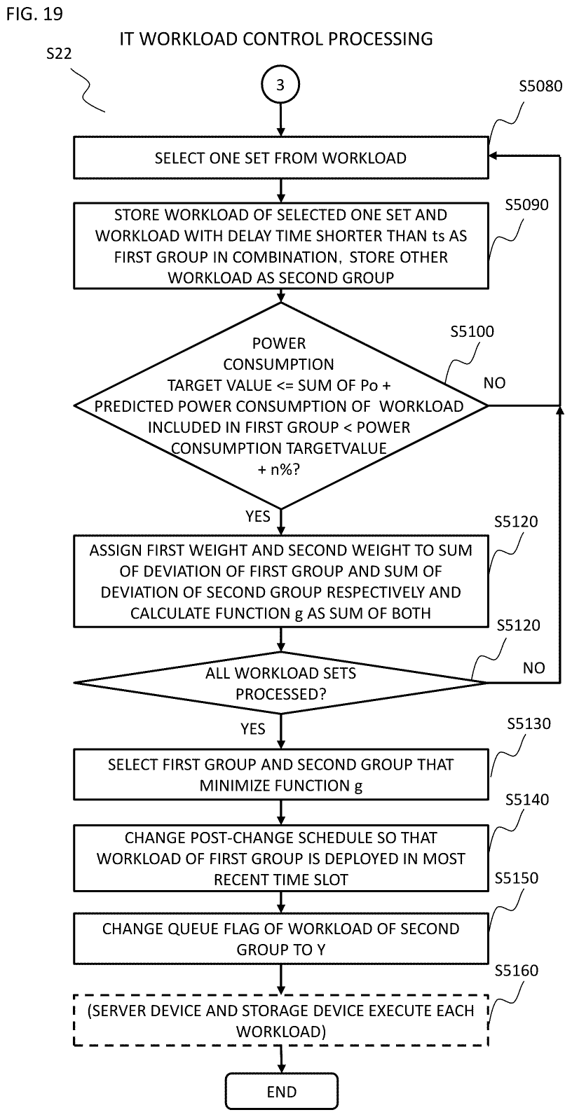

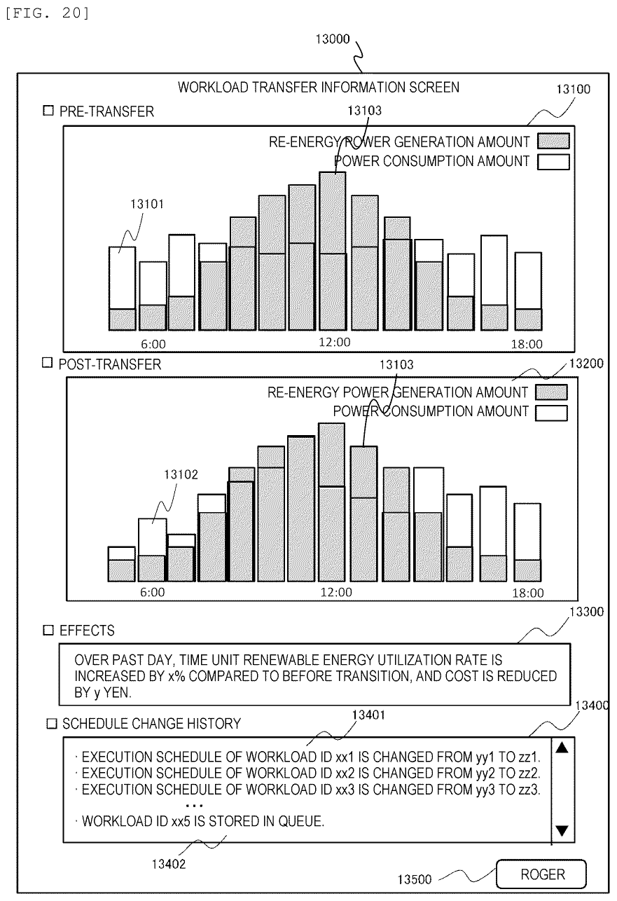

FIGS. 18 and 19 are flowcharts showing the IT workload control processing S22 (divided into two diagrams for convenience of the drawing). In the IT workload control processing, a batch workload to be actually deployed is determined to approach a power consumption target value in each time slot determined by the calculated value of the parameter α. At this time, in addition to the approach to the power consumption target value, in consideration of a deviation from the prediction of the power consumption of each batch workload, the batch workload to be deployed is determined such that a sum of the deviations from the prediction of the power consumption of each batch workload is reduced as much as possible in the time slot with a small risk allowance.

As shown in FIG. 18, the IT workload control program 8900 calculates a weight value (first weight value) related to a risk allowance in a most recent time slot (S5000).

For example, the IT workload control program 8900 sets an inverse of the risk allowance in the most recent time slot as the first weight value. A calculation method of the first weight value described here is one example, and the first weight value can be a monotonically decreasing function for the risk allowance.

The IT workload control program 8900 calculates a weight value (second weight value) related to a risk allowance in a time slot after the most recent time slot (S5010).

For example, the IT workload control program 8900 sets an inverse of an average value of the risk allowances in a time slot after the most recent time slot as the second weight value. The calculation method of the second weight value described here is one example, and the second weight value can be a monotonically decreasing function for the risk allowance.

The IT workload control program 8900 sets a prediction value of the power consumption other than the batch workload as a variable Po in the most recent time slot (S5020). Specifically, the IT workload control program 8900 refers to the time slot table 8200 and sets, as Po, a value obtained by subtracting the value of the batch power consumption prediction 8250 from the value of the power consumption prediction 8230 of the record related to the most recent time slot.

The IT workload control program 8900 acquires the batch workload in the most recent time slot and all the batch workloads accumulated in the time slot immediately before the most recent time slot as the current queue (S5030). Specifically, the IT workload control program 8900 refers to the execution schedule 8550 of each record in the workload table 8500 and acquires a record related to the most recent time slot and a record of which the queue flag 8580 is “Y”.

The IT workload control program 8900 sorts the respective batch workloads acquired in S5030 in an ascending order of the delay limit time (from one with the earliest order) (S5040). Specifically, the IT workload control program 8900 stores each record acquired in S5030 in which the delay limit time 8570 of the record related to the time slot is sorted in an order close to the current time point.

Then, the parameter determination program 8700 adds, to Po, the prediction values of the power consumptions of the respective batch workloads in the order of sorting (S5040). Specifically, the parameter determination program 8700 adds the value of the power consumption prediction 8520 of each record sorted in S5030 to Po in this order (the batch workload with the same delay limit time is added to the prediction value of the power consumption at one time).

The parameter determination program 8700 identifies a time slot ts to which the batch workload obtained by adding the prediction value of the power consumption when Po exceeds the power consumption target value in the addition processing of S5040 belongs (S5050). As can be seen from the above, a plurality of batch workloads may belong to the time slot ts.

The parameter determination program 8700 creates one or a plurality of sets of batch workloads by dividing the batch workloads belonging to time slot ts into two groups (for example, when the number of batch workloads belonging to the time slot ts is three, four sets of “0 and 1”, “1 and 2”, “2 and 1”, and “1 and 0” are created) (S5060).

The parameter determination program 8700 resets Po to the value in S5020 (S5070).

Subsequently, as shown in FIG. 19, the parameter determination program 8700 selects one set from among the plurality of sets generated in S5060 (S5080).

The parameter determination program 8700 stores the batch workload of one set selected in S5080 and the batch workload whose delay limit time is shorter (earlier) than the time slot ts as a first group in combination, and stores the batch workload of the other group in the set selected in S5080 and the batch workload of the other group whose delay limit time is longer (later) than the time slot ts as a second group in combination (S5090).

The parameter determination program 8700 determines whether a sum of the power consumption Po other than the batch workload and the power consumption of the batch workload of the first group is approximate to the power consumption target value (S5100).

For example, the parameter determination program 8700 determines whether a total value of Po set in S5070 and the power consumption of the batch workload related to the first group (acquired from the power consumption prediction 8520 of the workload table 8500) is equal to or greater than the power consumption target value and equal to or less than (power consumption target value +predetermined error allowable value n %).

When the sum is approximate to the power consumption target value (S5100: YES), the parameter determination program 8700 executes the processing of S5110. When the sum is not approximate to the power consumption target value (S5100: NO), the parameter determination program 8700 repeats the processing from S5080 onwards to select another set.

In S5110, the parameter determination program 8700 calculates a value of an evaluation function g indicating a degree of seriousness of the deviation from the prediction value of the power consumption of the batch workload based on the power consumption of the batch workloads of the first group and the second group.

For example, the parameter determination program 8700 calculates the value of the evaluation function g for the group of the batch workload acquired in S5080 by the following formula.

Evaluation function g=(first weight value)×(sum of deviation of first group)+(second weight value)×(sum of deviation of second group)

In the calculation method for the sum of the deviations of the first group, the parameter determination program 8700 calculates an absolute value of a difference between the prediction value of the power consumption (acquired from the power consumption prediction 8520 of the workload table 8500) and a past average prediction value or a median value of the power consumption (calculated from the power consumption 8620 and the probability 8630 of the workload power consumption prediction distribution table 8600) for each batch workload belonging to the first group, and obtains a result by summing up the calculated absolute values. The same applies to the sum of the deviation of the second group.

The evaluation function described here is one example, and may be a function in consideration of a magnitude of an allowance of the deviation between the prediction value and the actual value.

The parameter determination program 8700 checks whether the value of the evaluation function g is calculated for all the sets of the workloads created in S5060 (S5120). When the value of the evaluation function g is calculated for all the sets of the workloads (S5120: YES), the parameter determination program 8700 executes the processing of S5130. When there is a set of workloads for which the value of the evaluation function g is not calculated (S5120: NO), the parameter determination program 8700 repeats the processing from S5080 onwards in order to acquire the set of the workloads.

In S5130, the parameter determination program 8700 compares the values of the evaluation functions g of each of the sets of workloads, searches for a set having a minimum value of the evaluation function g, and identifies the first group and the second group associated with the set.

Then, the parameter determination program 8700 deploys the batch workload of the first group identified in S5130 to be executed in the most recent time slot (S5140). For example, the parameter determination program 8700 refers to the workload table 8500, sets a time point of the most recent time slot to the post-change execution schedule 8560 of the record related to each batch workload of the first group, and sets “N” to the queue flag 8580.

In addition, the parameter determination program 8700 sets the batch workload of the second group identified in S5130 to wait for a queue (not executed in the most recent time slot) (S5150). For example, the parameter determination program 8700 refers to the workload table 8500, and sets “Y” to the queue flag 8580 of the record related to each batch workload of the second group. With the above, the IT workload control processing S22 ends.

Thereafter, the server device 3000 and the storage device 4000 execute each workload (job) according to the content of the workload table 8500 (S5160).

### Workload Transfer Information Screen

FIG. 20 is a diagram showing an example of the workload transfer information screen 13000. The workload transfer information screen 13000 includes a pre-transfer information display field 13100 in which a value 13101 of the power consumption amount in each time slot is displayed when the IT workload control processing S22 is not executed (when the execution timing (time slot) of the batch job is not changed), a post-transfer information display field 13200 in which an actual value 13102 of the power consumption amount in each time slot after execution of the IT workload control processing S22 is displayed, an effect display field 13300 in which information indicating an effect of the execution of the IT workload control processing S22 is displayed, a schedule change history display field 13400 in which the information of the batch workload whose execution timing (time slot) is changed from the IT workload control processing S22 is displayed, and a roger designation field 13500 in which the workload transfer information screen 13000 is closed.

In each of the pre-transfer information display field 13100 and post-transfer information display field 13200, the actual value 13103 of the power generation amount of the renewable energy in each time slot is displayed as a comparison.

In the effect display field 13300, information such as an increase rate of the utilization rate of the renewable energy and a decrease rate of cost per unit time calculated in the past predetermined period based on the IT workload control processing S22 is displayed.

In the schedule change history display field 13400, information 13401 of the batch workload in which the time slot to be executed in the IT workload control processing S22 is changed and information 13402 of the batch workload in which the slot to be executed in the time slot after the most recent time slot is changed are displayed.

The workload transfer information screen 13000 displays the past data, and may also display information (such as power consumption) of the batch workload in the most recent time slot to be executed.

As described above, the workload control support device according to the embodiment calculates, based on each prediction value of the delay limit time and the power consumption amount of each workload, a target value of the power consumption amount in the future time slot to satisfy a target value for the re-energy rate and a condition for cost related to the utilization of the renewable energy, determines a timing of each workload to be executed in the future time slot based on the calculated target value of the power consumption amount, and executes each workload at the determined timing.

That is, the workload control support device according to the embodiment determines the target value of the power consumption in consideration of the cost and the re-energy rate, and determines and executes the timing of each workload to be executed in the future time slot based on the target value of the power consumption. Accordingly, it is possible to use the renewable energy and the workload according to a user need in consideration of the cost and the re-energy rate.

As described above, the workload control support device according to the embodiment can control each workload to be executed based on the renewable energy while taking cost effectiveness into consideration.

The workload control support device according to the embodiment receives, from a user, a designation of a control principle as to which of the re-energy rate and the cost is emphasized, when the control principle to emphasize the re-energy rate is designated, identifies a pattern of the parameter α to optimize the utilization rate of the renewable energy, and calculates a target value of the power consumption amount based on the identified pattern. On the other hand, when the principle to emphasize the cost is designated by the user, identifies the parameter α to optimize the cost related to the utilization of the renewable energy, and calculates the target value of the power consumption amount based on the identified pattern.

Accordingly, it is possible to set an appropriate target value of the power consumption based on an option as to whether to emphasize the cost or emphasize the re-energy rate.

The workload control support device according to the embodiment calculates, when the control principle to emphasize the cost is designated, a target value of the power consumption amount based on the pattern of the parameter α, which satisfies the target value of the re-energy rate set by the user and optimizes the cost related to the utilization of the renewable energy.

Accordingly, it is possible to set a target value of a power amount that emphasizes the cost only when the target value of the re-energy rate is achieved. Accordingly, a stable use of the renewable energy can be ensured.

The workload control support device according to the embodiment creates the pattern of the parameter α that satisfies the delay limit time, and calculates, based on the created pattern of the parameter α and the prediction value of the power consumption amount, the target value of the power consumption amount to satisfy the condition for the re-energy rate and the cost.

Accordingly, the prediction value of the power consumption amount can be calculated by appropriately distributing the execution timing of each workload that can be delayed.

The workload control support device according to the embodiment calculates a risk allowance indicating a risk due to uncertainty of the prediction value of the power consumption amount, and determines the timing of each workload based on the risk allowance, a difference between the prediction value of the power consumption of each workload and a past value of the power consumption, and the target value of the power consumption amount.

Accordingly, an appropriate execution timing of the workload can be set in consideration of uncertainty of the prediction value. The execution timing of the workload can be determined in consideration of a risk based on a deviation between a prediction value of the power consumption and an actual result.

The workload control support device according to the embodiment calculates the risk allowance based on a difference between a prediction value of a power generation amount related to the renewable energy and the target value of the power consumption amount.

Accordingly, it is possible to consider the risk derived from the uncertainty of the power generation amount of the renewable energy.

The workload control support device according to the embodiment displays information on a timing and power consumption of each of the workloads scheduled to be executed, or information on each of the workloads executed and the power consumption of each of the workloads.

Accordingly, the user can check whether the execution timing of the workload is appropriately determined.

The invention is not limited to the embodiment described above and can be implemented using any component without departing from the gist of the invention. The embodiment and modifications described above are merely examples, and the invention is not limited to the contents thereof as long as the characteristics of the invention are not impaired. Although various embodiments and modifications have been described above, the invention is not limited to the contents thereof and other aspects conceivable within the scope of a technical idea of the invention are also included within the scope of the invention.

For example, some of the functions of each device in the embodiment may be provided in another device, or functions of another device may be provided in the same device.

In addition, the configuration of the program described in the embodiment is one example, and for example, a part of the program may be incorporated into another program, or a plurality of programs may be implemented as one program.

In the embodiment, the delay limit time is used as an executable time, and the executable time may be specifically designated.

In the embodiment, the case of the workload in which the workload is loaded into the data center is described, and the invention is also applicable to information processing performed in other facilities or networks.

### REFERENCE SIGNS LIST

1: workload control system
1000: data center
2000: management computer

1. A workload control support device comprising:
a processor;
a memory;
a parameter determination unit configured to acquire a prediction value of an executable period and a power consumption amount of each of a plurality of workloads that consume power scheduled to be executed in a future time period, and calculate, based on each acquired prediction value of the executable period and the power consumption amount, a target value of the power consumption amount in the future time period to satisfy a condition for a utilization rate of renewable energy in the power consumption in the future time period and a condition for cost related to utilization of the renewable energy; and
a workload control unit configured to determine a timing of each workload to be executed in the future time period based on the calculated target value of the power consumption amount.

2. The workload control support device according to claim 1, wherein the parameter determination unit
receives a designation of a parameter indicating a principle as to which of the condition for the utilization rate and the condition for the cost is emphasized,
when a principle to emphasize the condition for the utilization rate is designated, identifies a pattern of an execution timing of each workload to optimize the utilization rate of the renewable energy, and calculates a target value of the power consumption amount in the future time period based on the identified pattern, and
when a principle to emphasize the condition for the cost is designated, identifies a pattern of the execution timing of each workload to optimize the cost related to the utilization of the renewable energy, and calculates the target value of the power consumption amount in the future time period based on the identified pattern.

3. The workload control support device according to claim 2, wherein when the principle to emphasize the condition for the cost is designated, the parameter determination unit identifies a pattern of the execution timing of each workload which satisfies a minimum condition of the utilization rate of the renewable energy and optimizes the cost related to the utilization of the renewable energy, and calculates the target value of the power consumption amount in the future time period based on the identified pattern.

4. The workload control support device according to claim 1, wherein the parameter determination unit
creates a condition for an execution timing of each workload that satisfies the acquired executable period of each workload, and
calculates, based on the created condition for the execution timing and the acquired prediction value of the power consumption amount, the target value of the power consumption amount in the future time period to satisfy the condition for the utilization rate and the condition for the cost.

5. The workload control support device according to claim 1, further comprising a risk allowance calculation unit configured to calculate a risk allowance indicating a risk due to uncertainty of the prediction value of the power consumption amount in the future time period based on a predetermined algorithm,
wherein the workload control unit determines the timing of each workload to be executed in the future time period, based on the calculated risk allowance, a difference between the prediction value of the power consumption of each workload in the future time period and a past value of the power consumption of each workload, and the calculated target value of the power consumption amount.

6. The workload control support device according to claim 5, wherein the risk allowance calculation unit calculates the risk allowance based on a difference between a prediction value of a power generation amount related to the renewable energy in the future time period and the calculated target value of the power consumption amount in the future time period.

7. The workload control support device according to claim 1, wherein the workload control unit displays information on a timing and power consumption of each of the workloads to be executed in the future time period, or information on each of the executed workloads and the power consumption of each of the workloads.

8. The workload control support device according to claim 1, wherein the workload control unit causes a predetermined device to execute each of the workloads at the determined timing.

9. A workload control support method that causes an information processing device to execute:
parameter determination processing of acquiring a prediction value of an executable period and a power consumption amount of each of a plurality of workloads that consume power scheduled to be executed in a future time period, and calculating, based on each acquired prediction value of the executable period and the power consumption amount, a target value of the power consumption amount in the future time period to satisfy a condition for a utilization rate of renewable energy in the power consumption in the future time period and a condition for cost related to utilization of the renewable energy; and
workload control processing of determining a timing of each workload to be executed in the future time period based on the calculated target value of the power consumption amount, and executing each workload at the determined timing.
